(19) United States
(12) Patent Application Publication
(10) Pub. No.: US 2018/0062791 A1
(43) Pub. Date: Mar. 1, 2018

(54) EFFICIENT AND FAST DISTRIBUTION OF AN UPGRADED DATA OBJECT

(71) Applicant: International Business Machines Corporation, Armonk, NY (US)

(72) Inventors: Jason K. Resch, Chicago, IL (US); Wesley B. Leggette, Chicago, IL (US); Andrew G. Peake, Chicago, IL (US)

(21) Appl. No.: 15/806,241

(22) Filed: Nov. 7, 2017

Related U.S. Application Data
(63) Continuation-in-part of application No. 13/775,555, filed on Feb. 25, 2013.
(60) Provisional application No. 61/605,856, filed on Mar. 2, 2012.

(51) Int. Cl. H04L 1/00; G06F 11/00; H04L 29/08

(52) U.S. Cl. CPC H04L 1/0076; H04L 67/1097; H04L 1/0078; G06F 11/004

(57) ABSTRACT

A method includes dividing an updated data object into “n” data object portions. “N” corresponds to a number of sites in which a set of storage units (SUs) is located. The method further includes sending “n” write requests to “n” SUs. Each of the “n” SUs is in a different site. A first SU of the “n” SUs is in a first site. A first write request of the “n” write requests includes a first data object portion. The first write request is sent to the first SU. The method further includes sharing the “n” data object portions such that each of the “n” SUs have the updated data object. The method further includes dispersed error encoding, by the first SU, the updated data object to generate a first and second encoded data slice for each of a plurality of sets of encoded data slices.

### CROSS-REFERENCE TO RELATED APPLICATIONS

This application claims priority pursuant to 35 U.S.C. §120 as a continuation-in-part of U.S. Utility application Ser. No. 13/775,555, entitled “MODIFYING AN INDEX NODE OF A HIERARCHICAL DISPERSED STORAGE INDEX,” filed Feb. 25, 2013 which claims priority pursuant to 35 U.S.C. §119(e) to U.S. Provisional Application No. 61/605,856, entitled “UTILIZING AN INDEX OF A DISTRIBUTED STORAGE AND TASK NETWORK,” filed Mar. 2, 2012 which are both incorporated herein by reference in their entirety and made part of the present U.S. Utility Patent Application for all purposes.

### STATEMENT REGARDING FEDERALLY SPONSORED RESEARCH OR DEVELOPMENT

Not Applicable.

### INCORPORATION-BY-REFERENCE OF MATERIAL SUBMITTED ON A COMPACT DISC

Not Applicable.

### BACKGROUND OF THE INVENTION

### Technical Field of the Invention

This invention relates generally to computer networks and more particularly to dispersing error encoded data.

### Description of Related Art

Computing devices are known to communicate data, process data, and/or store data. Such computing devices range from wireless smart phones, laptops, tablets, personal computers (PC), work stations, and video game devices, to data centers that support millions of web searches, stock trades, or on-line purchases every day. In general, a computing device includes a central processing unit (CPU), a memory system, user input/output interfaces, peripheral device interfaces, and an interconnecting bus structure.

As is further known, a computer may effectively extend its CPU by using “cloud computing” to perform one or more computing functions (e.g., a service, an application, an algorithm, an arithmetic logic function, etc.) on behalf of the computer. Further, for large services, applications, and/or functions, cloud computing may be performed by multiple cloud computing resources in a distributed manner to improve the response time for completion of the service, application, and/or function. For example, Hadoop is an open source software framework that supports distributed applications enabling application execution by thousands of computers.

In addition to cloud computing, a computer may use “cloud storage” as part of its memory system. As is known, cloud storage enables a user, via its computer, to store files, applications, etc. on an Internet storage system. The Internet storage system may include a RAID (redundant array of independent disks) system and/or a dispersed storage system that uses an error correction scheme to encode data for storage.

As is further known, updating an object stored in a dispersed storage system can incur performance penalties because the update must be propagated throughout the system.

### BRIEF DESCRIPTION OF THE SEVERAL VIEWS OF THE DRAWING(S)

FIG. 1 is a schematic block diagram of an embodiment of a dispersed or distributed storage network (DSN) in accordance with the present invention;

FIG. 2 is a schematic block diagram of an embodiment of a computing core in accordance with the present invention;

FIG. 3 is a schematic block diagram of an example of dispersed storage error encoding of data in accordance with the present invention;

FIG. 4 is a schematic block diagram of a generic example of an error encoding function in accordance with the present invention;

FIG. 5 is a schematic block diagram of a specific example of an error encoding function in accordance with the present invention;

FIG. 6 is a schematic block diagram of an example of a slice name of an encoded data slice (EDS) in accordance with the present invention;

FIG. 7 is a schematic block diagram of an example of dispersed storage error decoding of data in accordance with the present invention;

FIG. 8 is a schematic block diagram of a generic example of an error decoding function in accordance with the present invention;

FIGS. 9A and 9B are schematic block diagrams of an example of distributing an updated data object to a set of storage units in accordance with the present invention; and

FIG. 10 is a logic diagram of an example of a method of distributing an updated data object to a set of storage units in accordance with the present invention.

### DETAILED DESCRIPTION OF THE INVENTION

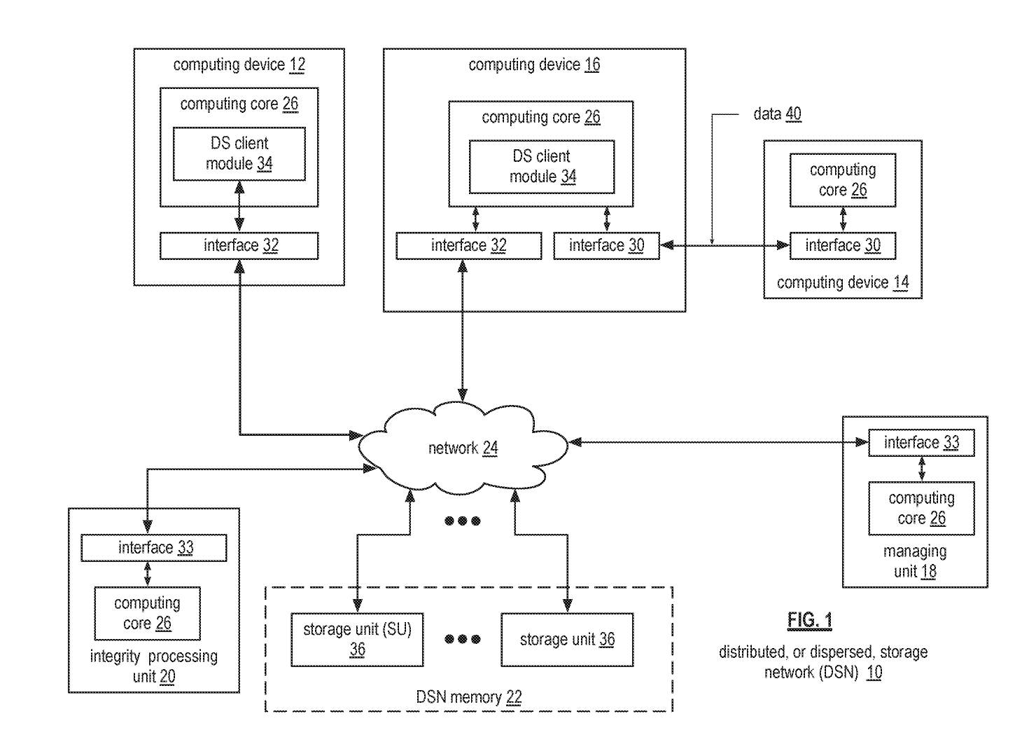

FIG. 1 is a schematic block diagram of an embodiment of a dispersed, or distributed, storage network (DSN) 10 that includes a plurality of computing devices 12 -16, a managing unit 18, an integrity processing unit 20, and a DSN memory 22. The components of the DSN 10 are coupled to a network 24, which may include one or more wireless and/or wire lined communication systems; one or more non-public intranet systems and/or public internet systems; and/or one or more local area networks (LAN) and/or wide area networks (WAN).

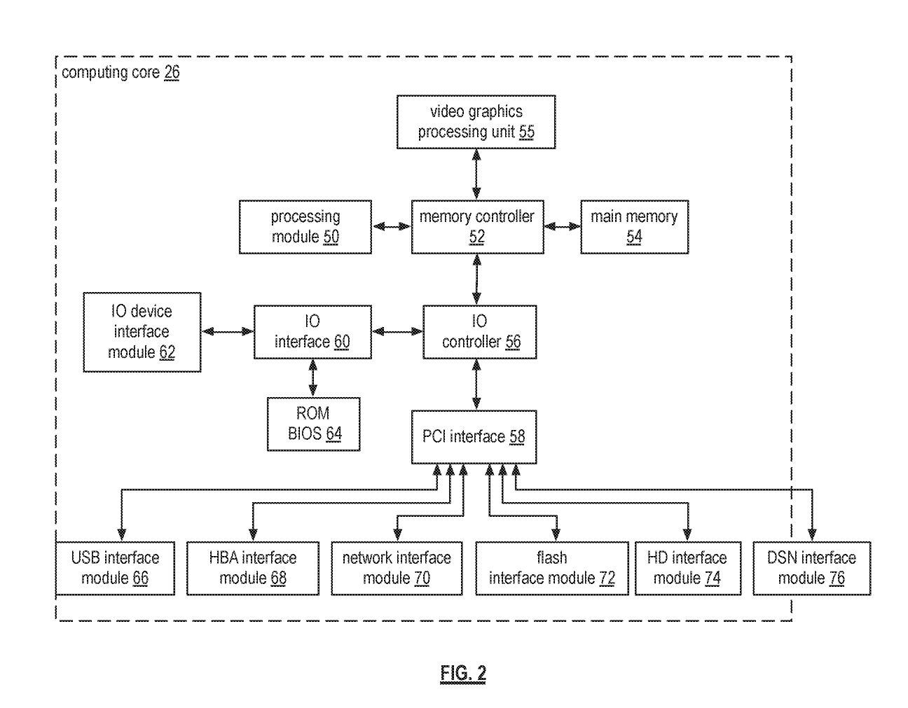

The DSN memory 22 includes a plurality of storage units 36 that may be located at geographically different sites (e.g., one in Chicago, one in Milwaukee, etc.), at a common site, or a combination thereof. For example, if the DSN memory 22 includes eight storage units 36, each storage unit is located at a different site. As another example, if the DSN memory 22 includes eight storage units 36, all eight storage units are located at the same site. As yet another example, if the DSN memory 22 includes eight storage units 36, a first pair of storage units are at a first common site, a second pair of storage units are at a second common site, a third pair of storage units are at a third common site, and a fourth pair of storage units are at a fourth common site. Note that a DSN memory 22 may include more or less than eight storage units 36. Further note that each storage unit 36 includes a computing core (as shown in FIG. 2, or components thereof) and a plurality of memory devices for storing dispersed error encoded data.

Each of the computing devices 12-16, the managing unit 18, and the integrity processing unit 20 include a computing core 26, which includes network interfaces 30-33. Computing devices 12-16 may each be a portable computing device and/or a fixed computing device. A portable computing device may be a social networking device, a gaming device, a cell phone, a smart phone, a digital assistant, a digital music player, a digital video player, a laptop computer, a handheld computer, a tablet, a video game controller, and/or any other portable device that includes a computing core. A fixed computing device may be a computer (PC), a computer server, a cable set-top box, a satellite receiver, a television set, a printer, a fax machine, home entertainment equipment, a video game console, and/or any type of home or office computing equipment. Note that each of the managing unit 18 and the integrity processing unit 20 may be separate computing devices, may be a common computing device, and/or may be integrated into one or more of the computing devices 12-16 and/or into one or more of the storage units 36.

Each interface 30, 32, and 33 includes software and hardware to support one or more communication links via the network 24 indirectly and/or directly. For example, interface 30 supports a communication link (e.g., wired, wireless, direct, via a LAN, via the network 24, etc.) between computing devices 14 and 16. As another example, interface 32 supports communication links (e.g., a wired connection, a wireless connection, a LAN connection, and/or any other type of connection to/from the network 24) between computing devices 12 & 16 and the DSN memory 22. As yet another example, interface 33 supports a communication link for each of the managing unit 18 and the integrity processing unit 20 to the network 24.

Computing devices 12 and 16 include a dispersed storage (DS) client module 34, which enables the computing device to dispersed storage error encode and decode data as subsequently described with reference to one or more of FIGS. 3-8. In this example embodiment, computing device 16 functions as a dispersed storage processing agent for computing device 14. In this role, computing device 16 dispersed storage error encodes and decodes data on behalf of computing device 14. With the use of dispersed storage error encoding and decoding, the DSN 10 is tolerant of a significant number of storage unit failures (the number of failures is based on parameters of the dispersed storage error encoding function) without loss of data and without the need for a redundant or backup copies of the data. Further, the DSN 10 stores data for an indefinite period of time without data loss and in a secure manner (e.g., the system is very resistant to unauthorized attempts at accessing the data).

In operation, the managing unit 18 performs DS management services. For example, the managing unit 18 establishes distributed data storage parameters (e.g., vault creation, distributed storage parameters, security parameters, billing information, user profile information, etc.) for computing devices 12-14 individually or as part of a group of user devices. As a specific example, the managing unit 18 coordinates creation of a vault (e.g., a virtual memory block associated with a portion of an overall namespace of the DSN) within the DSTN memory 22 for a user device, a group of devices, or for public access and establishes per vault dispersed storage (DS) error encoding parameters for a vault. The managing unit 18 facilitates storage of DS error encoding parameters for each vault by updating registry information of the DSN 10, where the registry information may be stored in the DSN memory 22, a computing device 12-16, the managing unit 18, and/or the integrity processing unit 20.

The DSN managing unit 18 creates and stores user profile information (e.g., an access control list (ACL)) in local memory and/or within memory of the DSN memory 22. The user profile information includes authentication information, permissions, and/or the security parameters. The security parameters may include encryption/decryption scheme, one or more encryption keys, key generation scheme, and/or data encoding/decoding scheme.

The DSN managing unit 18 creates billing information for a particular user, a user group, a vault access, public vault access, etc. For instance, the DSTN managing unit 18 tracks the number of times a user accesses a non-public vault and/or public vaults, which can be used to generate a per-access billing information. In another instance, the DSTN managing unit 18 tracks the amount of data stored and/or retrieved by a user device and/or a user group, which can be used to generate a per-data-amount billing information.

As another example, the managing unit 18 performs network operations, network administration, and/or network maintenance. Network operations includes authenticating user data allocation requests (e.g., read and/or write requests), managing creation of vaults, establishing authentication credentials for user devices, adding/deleting components (e.g., user devices, storage units, and/or computing devices with a DS client module 34) to/from the DSN 10, and/or establishing authentication credentials for the storage units 36. Network administration includes monitoring devices and/or units for failures, maintaining vault information, determining device and/or unit activation status, determining device and/or unit loading, and/or determining any other system level operation that affects the performance level of the DSN 10. Network maintenance includes facilitating replacing, upgrading, repairing, and/or expanding a device and/or unit of the DSN 10.

The integrity processing unit 20 performs rebuilding of ‘bad’ or missing encoded data slices. At a high level, the integrity processing unit 20 performs rebuilding by periodically attempting to retrieve/list encoded data slices, and/or slice names of the encoded data slices, from the DSN memory 22. For retrieved encoded slices, they are checked for errors due to data corruption, outdated version, etc. If a slice includes an error, it is flagged as a ‘bad’ slice. For encoded data slices that were not received and/or not listed, they are flagged as missing slices. Bad and/or missing slices are subsequently rebuilt using other retrieved encoded data slices that are deemed to be good slices to produce rebuilt slices. The rebuilt slices are stored in the DSTN memory 22.

FIG. 2 is a schematic block diagram of an embodiment of a computing core 26 that includes a processing module 50, a memory controller 52, main memory 54, a video graphics processing unit 55, an input/output (IO) controller 56, a peripheral component interconnect (PCI) interface 58, an IO interface module 60, at least one IO device interface module 62, a read only memory (ROM) basic input output system (BIOS) 64, and one or more memory interface modules. The one or more memory interface module(s) includes one or more of a universal serial bus (USB) interface module 66, a host bus adapter (HBA) interface module 68, a network interface module 70, a flash interface module 72, a hard drive interface module 74, and a DSN interface module 76.

The DSN interface module 76 functions to mimic a conventional operating system (OS) file system interface (e.g., network file system (NFS), flash file system (FFS), disk file system (DFS), file transfer protocol (FTP), web-based distributed authoring and versioning (WebDAV), etc.) and/or a block memory interface (e.g., small computer system interface (SCSI), internet small computer system interface (iSCSI), etc.). The DSN interface module 76 and/or the network interface module 70 may function as one or more of the interface 30-33 of FIG. 1. Note that the IO device interface module 62 and/or the memory interface modules 66-76 may be collectively or individually referred to as IO ports.

FIG. 3 is a schematic block diagram of an example of dispersed storage error encoding of data. When a computing device 12 or 16 has data to store it disperse storage error encodes the data in accordance with a dispersed storage error encoding process based on dispersed storage error encoding parameters. The dispersed storage error encoding parameters include an encoding function (e.g., information dispersal algorithm, Reed-Solomon, Cauchy Reed-Solomon, systematic encoding, non-systematic encoding, on-line codes, etc.), a data segmenting protocol (e.g., data segment size, fixed, variable, etc.), and per data segment encoding values. The per data segment encoding values include a total, or pillar width, number (T) of encoded data slices per encoding of a data segment i.e., in a set of encoded data slices); a decode threshold number (D) of encoded data slices of a set of encoded data slices that are needed to recover the data segment; a read threshold number (R)of encoded data slices to indicate a number of encoded data slices per set to be read from storage for decoding of the data segment; and/or a write threshold number (W) to indicate a number of encoded data slices per set that must be accurately stored before the encoded data segment is deemed to have been properly stored. The dispersed storage error encoding parameters may further include slicing information (e.g., the number of encoded data slices that will be created for each data segment) and/or slice security information (e.g., per encoded data slice encryption, compression, integrity checksum, etc.).

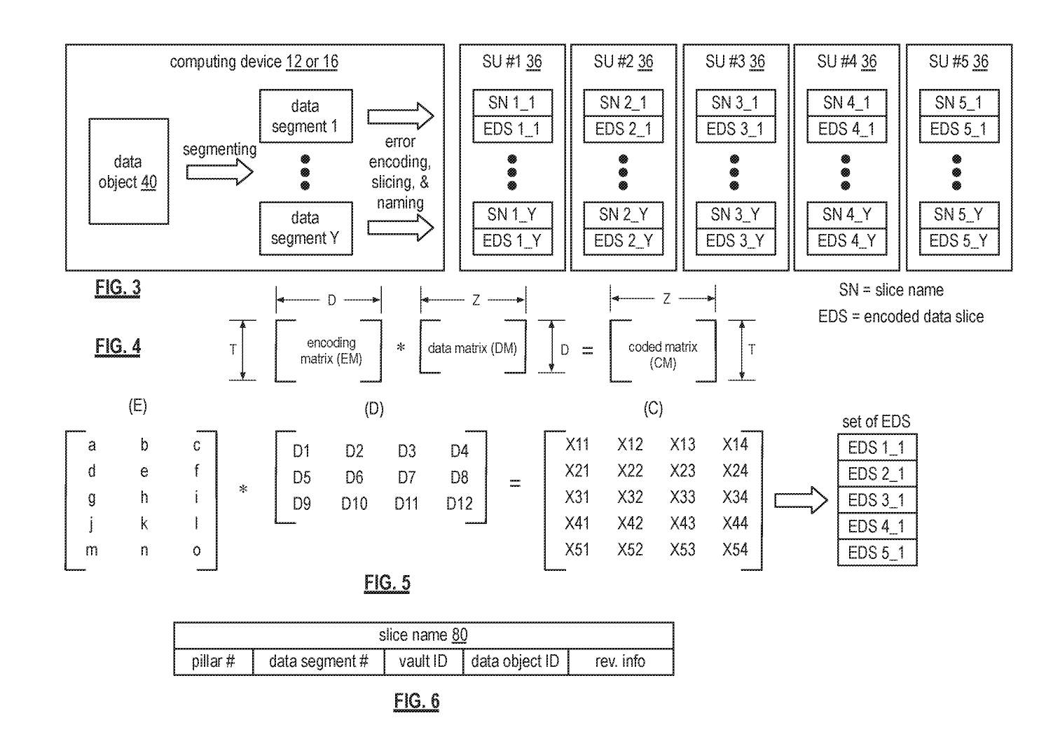

In the present example, Cauchy Reed-Solomon has been selected as the encoding function (a generic example is shown in FIG. 4 and a specific example is shown in FIG. 5); the data segmenting protocol is to divide the data object into fixed sized data segments; and the per data segment encoding values include: a pillar width of 5, a decode threshold of 3, a read threshold of 4, and a write threshold of 4. In accordance with the data segmenting protocol, the computing device 12 or 16 divides the data (e.g., a file (e.g., text, video, audio, etc.), a data object, or other data arrangement) into a plurality of fixed sized data segments (e.g., 1 through Y of a fixed size in range of Kilo-bytes to Tera-bytes or more). The number of data segments created is dependent of the size of the data and the data segmenting protocol.

The computing device 12 or 16 then disperse storage error encodes a data segment using the selected encoding function (e.g., Cauchy Reed-Solomon) to produce a set of encoded data slices. FIG. 4 illustrates a generic Cauchy Reed-Solomon encoding function, which includes an encoding matrix (EM), a data matrix (DM), and a coded matrix (CM). The size of the encoding matrix (EM) is dependent on the pillar width number (T) and the decode threshold number (D) of selected per data segment encoding values. To produce the data matrix (DM), the data segment is divided into a plurality of data blocks and the data blocks are arranged into D number of rows with Z data blocks per row. Note that Z is a function of the number of data blocks created from the data segment and the decode threshold number (D). The coded matrix is produced by matrix multiplying the data matrix by the encoding matrix.

FIG. 5 illustrates a specific example of Cauchy Reed-Solomon encoding with a pillar number (T) of five and decode threshold number of three. In this example, a first data segment is divided into twelve data blocks (D1-D12). The coded matrix includes five rows of coded data blocks, where the first row of X11-X14 corresponds to a first encoded data slice (EDS 1_1), the second row of X21-X24 corresponds to a second encoded data slice (EDS 2_1), the third row of X31-X34 corresponds to a third encoded data slice (EDS 3_1), the fourth row of X41-X44 corresponds to a fourth encoded data slice (EDS 4_1), and the fifth row of X51-X54 corresponds to a fifth encoded data slice (EDS 5_1). Note that the second number of the EDS designation corresponds to the data segment number.

Returning to the discussion of FIG. 3, the computing device also creates a slice name (SN) for each encoded data slice (EDS) in the set of encoded data slices. A typical format for a slice name 60 is shown in FIG. 6. As shown, the slice name (SN) 60 includes a pillar number of the encoded data slice (e.g., one of 1-T), a data segment number (e.g., one of 1-Y), a vault identifier (ID), a data object identifier (ID), and may further include revision level information of the encoded data slices. The slice name functions as, at least part of, a DSN address for the encoded data slice for storage and retrieval from the DSN memory 22.

As a result of encoding, the computing device 12 or 16 produces a plurality of sets of encoded data slices, which are provided with their respective slice names to the storage units for storage. As shown, the first set of encoded data slices includes EDS 1_1 through EDS 5_1 and the first set of slice names includes SN 1_1 through SN 5_1 and the last set of encoded data slices includes EDS 1_Y through EDS 5_Y and the last set of slice names includes SN 1_Y through SN 5_Y.

FIG. 7 is a schematic block diagram of an example of dispersed storage error decoding of a data object that was dispersed storage error encoded and stored in the example of FIG. 4. In this example, the computing device 12 or 16 retrieves from the storage units at least the decode threshold number of encoded data slices per data segment. As a specific example, the computing device retrieves a read threshold number of encoded data slices.

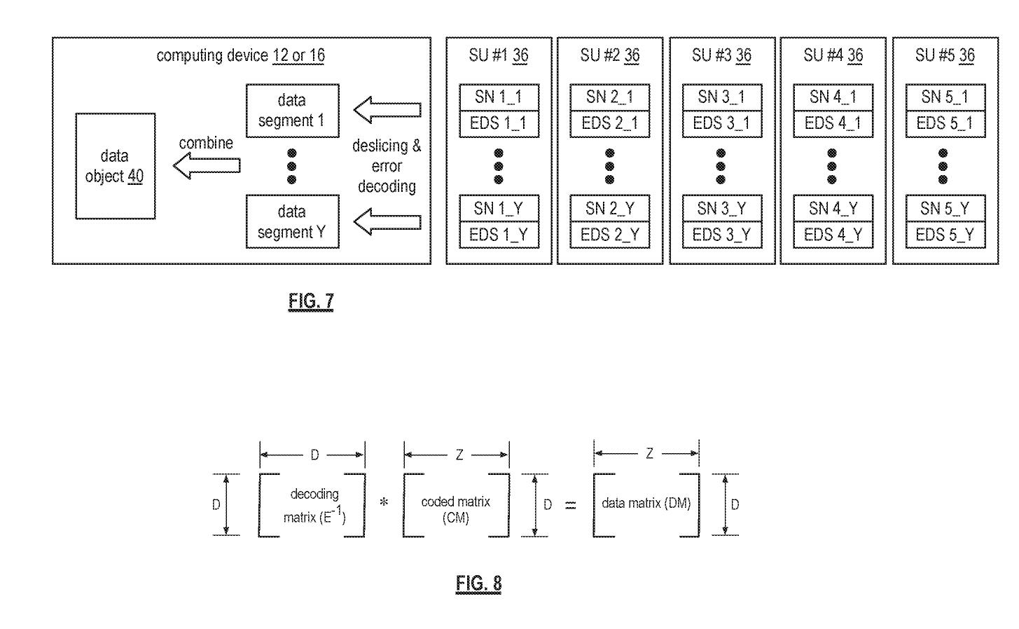

To recover a data segment from a decode threshold number of encoded data slices, the computing device uses a decoding function as shown in FIG. 8. As shown, the decoding function is essentially an inverse of the encoding function of FIG. 4. The coded matrix includes a decode threshold number of rows (e.g., three in this example) and the decoding matrix in an inversion of the encoding matrix that includes the corresponding rows of the coded matrix. For example, if the coded matrix includes rows 1, 2, and 4, the encoding matrix is reduced to rows 1, 2, and 4, and then inverted to produce the decoding matrix.

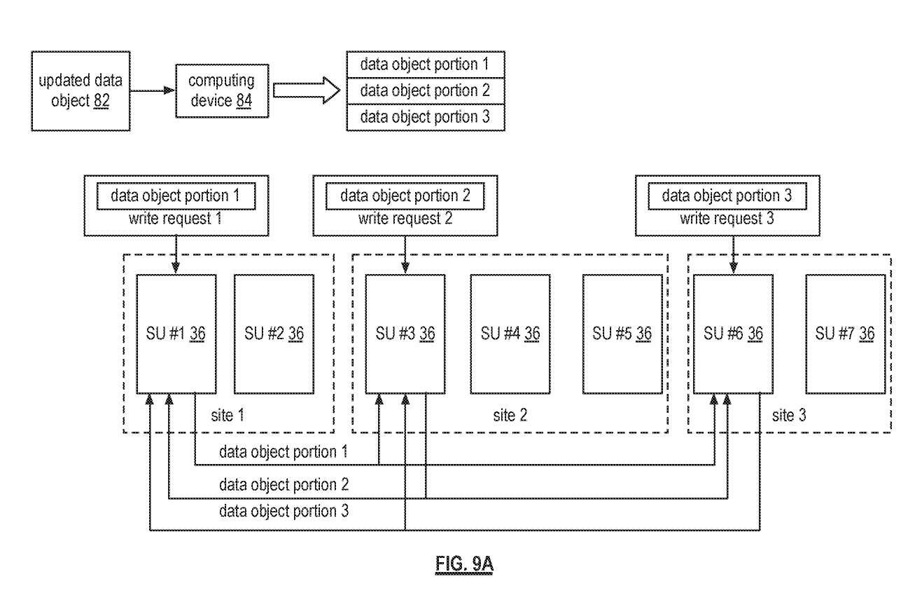

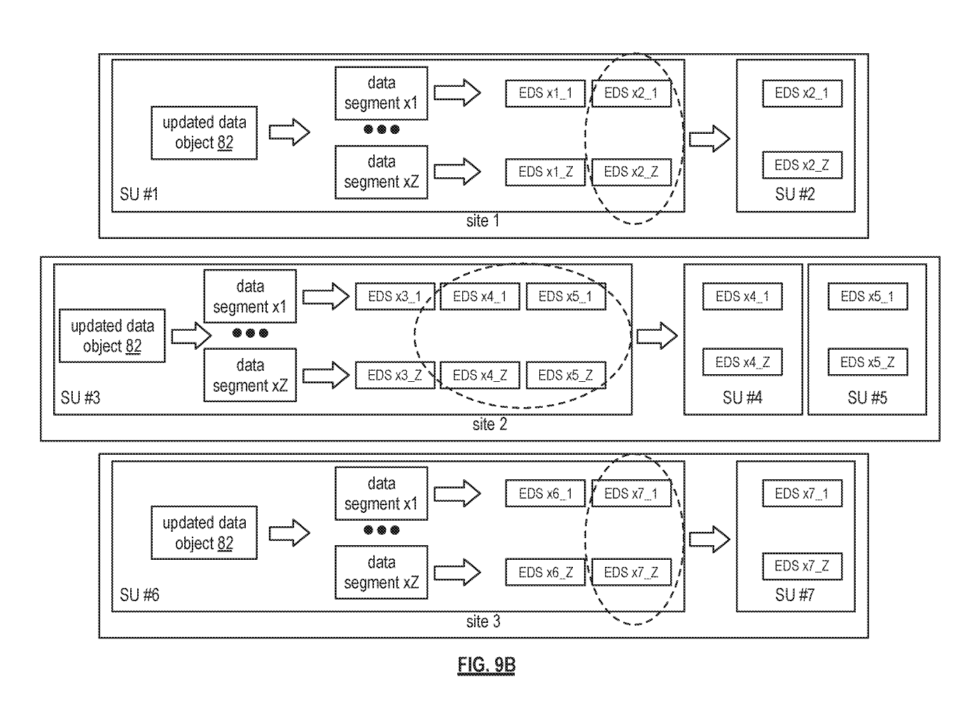

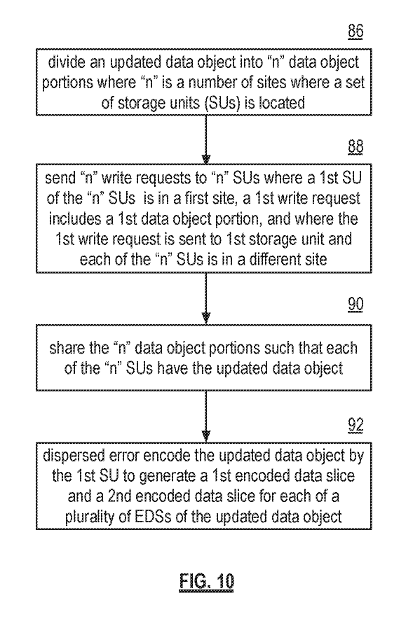

FIGS. 9A and 9B are schematic block diagrams of an example of distributing an updated data object 82 to a set of storage units (SU #1-SU #7) located at different geographic sites (sites 1-3) of the dispersed or distributed storage network (DSN) in a fast and efficient manner. FIG. 9A depicts distributing updated data object 82 to each storage unit site of the DSN. FIG. 9B depicts sharing updated data object 82 within each site.

Referring to FIG. 9A, SU #1 and SU #2 are located at site 1, SU #3, SU #4, and SU #5 are located at site 2, and SU #6 and SU #7 are located at site 3. Computing device 84 (e.g., computing device 12 or 16 of FIG. 1) divides updated data object 82 into three data object portions (e.g., data object portion 1, data object portion 2, and data object portion 3) based on the number of sites. As example of dividing updated data object 82, computing device 84 applies a unity matrix of an encoding matrix (e.g., blocks a-i of the Cauchy Reed-Solomon encoding matrix described in FIG. 5) to updated data object 82 to create data object portion 1. Computing device 84 applies a first redundancy matrix of a redundancy matrix of the encoding matrix (e.g., blocks j-l of the Cauchy Reed-Solomon encoding matrix described in FIG. 5) to updated data object 82 to create data object portion 2. Computing device 84 applies a second redundancy matrix of the redundancy matrix of the encoding matrix (e.g., blocks m-o of the Cauchy Reed-Solomon encoding matrix described in FIG. 5) to updated data object 82 to create data object portion 3.

Computing device 84 sends a write request including a portion of the updated data object 82 to one storage unit in each site. For example, computing device 84 sends write request 1 including data object portion 1 to SU #1 of site 1, write request 2 including data object portion 2 to SU #3 of site 2, and write request 3 including data object portion 3 to SU #6 of site 3. Each write request also includes a command to share the received data object portion with the other storage unit sites so that a storage unit in each site has all the portions of the updated data object 82. For example, write request 1 includes a command to send data object portion 1 to SU #3 and SU #6. Write request 2 includes a command to send data object portion 2 to SU #1 and SU #6, and write request 3 includes a command to send data object portion 3 to SU #1 and SU #3.

In response to write request 1, SU #1 sends data object portion 1 to SU #3 and SU #6. In response to write request 2, SU #3 sends data object portion 2 to SU #1 and SU #6, and in response to write request 3, SU #6 sends data object portion 3 to SU #1 and SU #3.

FIG. 9B includes SUs #1-7 located in sites 1-3 of FIG. 9A. Once each site has a full representation of updated data object 82, the updated data object 82 is shared internally within that site, thus not using any wide area networks (WAN) bandwidth to propagate the update, and utilizing the faster local area networks (LAN).

For example, SU #1 recreates updated data object 82 from data objects portions 1-3. Write request 1 further includes a command for SU #1 to dispersed error encode updated data object 82 to generate a first encoded data slice and a second encoded data slice for each of a plurality of sets of encoded data slices (e.g., EDS x1_1-EDS x1_Z and EDS x2_1-EDS x2_Z) of updated data object 82. Write request 1 may also include a command for SU #1 to generate a corresponding plurality of sets of slice names for EDS x1_1-EDS x1_Z and EDS x2_1-EDS x2_Z. In response to this command, SU #1 generates EDS x1_1-EDS x1_Z and EDS x2_1-EDS x2_Z. SU #1 keeps EDS x1_1-EDS x1_Z and sends EDS x2_1-EDS x2_Z to SU #2 for storage therein.

SU #3 recreates updated data object 82 from data objects portions 1-3. Write request 2 further includes a command for SU #3 to dispersed error encode updated data object 82 to generate a third, fourth, and fifth encoded data for each of the plurality of sets of encoded data slices (e.g., EDS x3_1-EDS x3_Z, EDS x4_1-EDS x4_Z, and EDS x5_1-EDS x5_Z). Write request 2 may also include a command for SU #3 to generate a corresponding plurality of sets of slice names for EDS x3_1-EDS x3_Z, EDS x4_1-EDS x4_Z, and EDS x5_1-EDS x5_Z. In response to this command, SU #3 generates EDS x3_1-EDS x3_Z, EDS x4_1-EDS x4_Z, and EDS x5_1-EDS x5_Z. SU #3 keeps EDS x3_1-EDS x3_Z and sends EDS x4_1-EDS x4_Z to SU #4, and EDS x5_1-EDS x5_Z to SU #5 for storage therein.

SU # 6 recreates updated data object 82 from data objects portions 1-3. Write request 3 further includes a command for SU #6 to dispersed error encode updated data object 82 to generate sixth and seventh encoded data for each of the plurality of sets of encoded data slices (e.g., EDS x6_1-EDS x6_Z, and EDS x7_1-EDS x7_Z). Write request 3 may also include a command for SU #6 to generate a corresponding plurality of sets of slice names for EDS x6_1-EDS x6_Z, and EDS x7_1-EDS x7_Z. In response to this command, SU #6 generates EDS x6_1-EDS x6_Z, and EDS x7_1-EDS x7_Z. SU #6 keeps EDS x6_1-EDS x6_Z and sends EDS x7_1-EDS x7_Z to SU #7 for storage therein.

FIG. 10 is a logic diagram of an example of a method of distributing an updated data object to a set of storage units. The method begins with step 86 where a computing device of a dispersed storage network (DSN) divides an updated data object into “n” data object portions, where “n” corresponds to a number of sites in which a set of storage units is located. For example, the computing device may divide the updated data object into portions by applying a unity matrix of an encoding matrix to the updated data object to create the first data object portion of the “n” data object portions, applying a first redundancy matrix of a redundancy matrix of the encoding matrix to the updated data object to create a second data object portion of the “n” data object portions, and applying a second redundancy matrix of the redundancy matrix of the encoding matrix to the updated data object to create a third data object portion of the “n” data object portions.

The method continues with step 88 where the computing device sends “n” write requests to “n” storage units of the set of storage units. Each of the “n” storage units is in a different site of the “n” number of sites. A first storage unit of the “n” storage units is in a first site of the “n” number of sites, a second storage unit of the “n” storage units is in a second site of the “n” number of sites, and a third storage unit of the “n” storage units is in a third site of the “n” number of sites. A first write request of the “n” write requests includes a first data object portion of the “n” data object portions, a second write request of the “n” write requests includes a second data object portion of the “n” data object portions, and a third write request of the “n” write requests includes a third data object portion of the “n” data object portions. The first write request is sent to the first storage unit, the second write request is sent to the second storage unit, and the third write request is sent to the third storage unit.

The method continues with step 90 where the “n” storage units share the “n” data object portions such that each of the “n” storage units have the updated data object. For example, a write request of the “n” write requests includes a command to share a received data object portion of the “n” data object portions with other storage units of the “n” storage units. For example, when “n” is three (e.g., there are only three sites), in response to the first write request, the first storage unit shares the first data portion with the second and third storage units. In response to the second write request, the second storage unit shares the second data portion with the first and third storage units. In response to the third write request, the third storage unit shares the third data portion with the first and second storage units.

The method continues with step 92 where the first storage unit dispersed error encodes the updated data object to generate a first encoded data slice and a second encoded data slice for each of a plurality of sets of encoded data slices of the updated data object. For example, a write request of the “n” write requests includes a command to dispersed error encode the updated data object to generate a plurality of local sets of encoded data slices of the plurality of sets of encoded data slices to be stored in storage units within the site of the storage unit. A write request of the “n” write requests further includes a command to send a corresponding set of the plurality of local sets of encoded data slices to each other storage unit of the storage units within the site of the storage unit. A write request of the “n” write requests may also include a command to generate a corresponding plurality of local sets of slice names for the plurality of local sets of encoded data slices slice names and to send the corresponding set of the corresponding plurality of local sets of slice names to each other storage unit of the storage units within the site of the storage unit.

For example, in response to the first write request, the first storage unit dispersed error encodes the updated data object to generate a first encoded data slice and a second encoded data slice for each of a plurality of sets of encoded data slices of the updated data object. The first storage unit sends the second encoded data slice for each of the plurality of sets of encoded data slices to another storage unit located in the first site. In response to the second write request, the second storage unit dispersed error encodes the updated data object to generate a third encoded data slice and a fourth encoded data slice for each of the plurality of sets of encoded data slices of the updated data object. The second storage unit sends the fourth encoded data slice for each of the plurality of sets of encoded data slices to another storage unit located in the second site. In response to the third write request, the third storage unit dispersed error encodes the updated data object to generate a fifth encoded data slice and a sixth encoded data slice for each of the plurality of sets of encoded data slices of the updated data object. The third storage unit sends the sixth encoded data slice for each of the plurality of sets of encoded data slices to another storage unit located in the third site.

It is noted that terminologies as may be used herein such as bit stream, stream, signal sequence, etc. (or their equivalents) have been used interchangeably to describe digital information whose content corresponds to any of a number of desired types (e.g., data, video, speech, audio, etc. any of which may generally be referred to as ‘data’).

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1. As may be used herein, the term “compares unfavorably”, indicates that a comparison between two or more items, signals, etc., fails to provide the desired relationship.

As may also be used herein, the terms “processing module”, “processing circuit”, “processor”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, and/or processing unit may be, or further include, memory and/or an integrated memory element, which may be a single memory device, a plurality of memory devices, and/or embedded circuitry of another processing module, module, processing circuit, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, and/or processing unit executes, hard coded and/or operational instructions corresponding to at least some of the steps and/or functions illustrated in one or more of the Figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, and/or any device that stores digital information. The memory device may be in a form a solid state memory, a hard drive memory, cloud memory, thumb drive, server memory, computing device memory, and/or other physical medium for storing digital information.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A method comprises:
dividing, by a computing device of a dispersed storage network (DSN), an updated data object into “n” data object portions, wherein “n” corresponds to a number of sites in which a set of storage units is located;
sending, by the computing device, “n” write requests to “n” storage units of the set of storage units, wherein a first storage unit of the “n” storage units is in a first site of the “n” number of sites, and wherein a first write request of the “n” write requests includes a first data object portion of the “n” data object portions, and wherein the first write request is sent to the first storage unit, and wherein each of the “n” storage units is in a different site of the “n” number of sites;
sharing, by the “n” storage units, the “n” data object portions such that each of the “n” storage units have the updated data object; and
dispersed error encoding, by the first storage unit, the updated data object to generate a first encoded data slice and a second encoded data slice for each of a plurality of sets of encoded data slices of the updated data object.

2. The method of claim 1, wherein the dividing the updated data object into the “n” data object portions comprises:
applying, by the computing device, a unity matrix of an encoding matrix to the updated data object to create the first data object portion of the “n” data object portions;
applying, by the computing device, a first redundancy matrix of a redundancy matrix of the encoding matrix to the updated data object to create a second data object portion of the “n” data object portions; and
applying, by the computing device, a second redundancy matrix of the redundancy matrix of the encoding matrix to the updated data object to create a third data object portion of the “n” data object portions.

3. The method of claim 1, wherein a write request of the “n” write requests includes a command instructing a storage unit of “n” storage units within a site of the “n” number of sites to:
share a received data object portion of the “n” data object portions with other storage units of the “n” storage units;
dispersed error encode the updated data object to generate a plurality of local sets of encoded data slices of the plurality of sets of encoded data slices to be stored in storage units within the site; and
send a corresponding set of the plurality of local sets of encoded data slices to each other storage unit of the storage units within the site.

4. The method of claim 3, wherein the command further instructs the storage unit to:
generate a corresponding plurality of local sets of slice names for the plurality of local sets of encoded data slices slice names; and
send the corresponding set of the corresponding plurality of local sets of slice names to each other storage unit of the storage units within the site.

5. The method of claim 1 further comprises:
sending, by the first storage unit, the second encoded data slice of each of the plurality of sets of encoded data slices to another storage unit in the first site.

6. The method of claim 1 further comprises:
dispersed error encoding, by a second storage unit in a second site of the “n” number of sites, the updated data object to generate a third encoded data slice and a fourth encoded data slice for each of the plurality of sets of encoded data slices.

7. The method of claim 6 further comprises:
sending, by the second storage unit, the fourth encoded data slice of each of the plurality of sets of encoded data slices to another storage unit in the second site.

8. The method of claim 1 further comprises:
dispersed error encoding, by a third storage unit in a third site of the “n” number of sites, the updated data object to generate a fifth encoded data slice and a sixth encoded data slice for each of the plurality of sets of encoded data slices.

9. The method of claim 8 further comprises:
sending, by the third storage unit, the sixth encoded data slice of each of the plurality of sets of encoded data slices to another storage unit in the third site.

10. A computer readable memory comprises:
a first memory element that stores operational instructions that, when executed by a computing device of a dispersed storage network (DSN), causes the computing device to:
divide an updated data object into “n” data object portions, wherein “n” corresponds to a number of sites in which a set of storage units is located;
send “n” write requests to “n” storage units of the set of storage units, wherein a first storage unit of the “n” storage units is in a first site of the “n” number of sites, and wherein a first write request of the “n” write requests includes a first data object portion of the “n” data object portions, and wherein the first write request is sent to the first storage unit, and wherein each of the “n” storage units is in a different site of the “n” number of sites;
a second memory element that stores operational instructions that, when executed by the “n” storage units, causes the “n” storage units to:
share the “n” data object portions such that each of the “n” storage units have the updated data object; and
a third memory element that stores operational instructions that, when executed by the first storage unit, causes the first storage unit to:
dispersed error encode the updated data object to generate a first encoded data slice and a second encoded data slice for each of a plurality of sets of encoded data slices of the updated data object.

11. The computer readable memory of claim 10, wherein the first memory element further stores operational instructions that, when executed by the computing device, causes the computing device to divide the updated data object into the “n” data object portions by:
applying a unity matrix of an encoding matrix to the updated data object to create the first data object portion of the “n” data object portions;
applying a first redundancy matrix of a redundancy matrix of the encoding matrix to the updated data object to create a second data object portion of the “n” data object portions; and
applying a second redundancy matrix of the redundancy matrix of the encoding matrix to the updated data object to create a third data object portion of the “n” data object portions.

12. The computer readable memory of claim 10, wherein a write request of the “n” write requests includes a command instructing a storage unit of “n” storage units within a site of the “n” number of sites to:
share a received data object portion of the “n” data object portions with other storage units of the “n” storage units;
dispersed error encode the updated data object to generate a plurality of local sets of encoded data slices of the plurality of sets of encoded data slices to be stored in storage units within the site; and
send a corresponding set of the plurality of local sets of encoded data slices to each other storage unit of the storage units within the site.

13. The computer readable memory of claim 12, wherein the command further instructs the storage unit to:
generate a corresponding plurality of local sets of slice names for the plurality of local sets of encoded data slices slice names; and
send the corresponding set of the corresponding plurality of local sets of slice names to each other storage unit of the storage units within the site.

14. The computer readable memory of claim 10, wherein the third memory element further stores operational instructions that, when executed by the first storage unit, causes the first storage unit to:
send the second encoded data slice of each of the plurality of sets of encoded data slices to another storage unit in the first site.

15. The computer readable memory of claim 10, wherein a fourth memory element that stores operational instructions that, when executed by a second storage unit in a second site of the “n” number of sites, causes the second storage unit to:
dispersed error encode the updated data object to generate a third encoded data slice and a fourth encoded data slice for each of the plurality of sets of encoded data slices.

16. The computer readable memory of claim 15, wherein the fourth memory element further stores operational instructions that, when executed by the second storage unit, causes the second storage unit to:
send the fourth encoded data slice of each of the plurality of sets of encoded data slices to another storage unit in the second site.

17. The computer readable memory of claim 10, wherein a fifth memory element that stores operational instructions that, when executed by a third storage unit in a third site of the “n” number of sites, causes the third storage unit to:
dispersed error encode the updated data object to generate a fifth encoded data slice and a sixth encoded data slice for each of the plurality of sets of encoded data slices.

18. The computer readable memory of claim 17, wherein the fifth memory element further stores operational instructions that, when executed by the third storage unit, causes the third storage unit to:
send the sixth encoded data slice of each of the plurality of sets of encoded data slices to another storage unit in the third site.
